(19) United States
(12) Patent Application Publication
(10) Pub. No.: US 2010/0300946 A1
(43) Pub. Date: Dec. 2, 2010

(54) Apparatus and Method for Concentrating A Fluid

(75) Inventors: Minh H. Nguyen, Werrington (AU); Anh Viet Bui, Werrington (AU)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: UNIVERSITY OF WESTERN SYDNEY, Werrington, New South Wales (AU)

(21) Appl. No.: 12/747,141

(22) PCT Filed: Dec. 10, 2008
(86) PCT No.: PCT/AU2008/001823

§ 371 Date: Jun. 9, 2010

(30) Foreign Application Priority Data
Dec. 10, 2007 (AU) 2007906697

(51) Int. Cl. B01D 61/36

(52) U.S. Cl. 210/149; 202/206

(57) ABSTRACT

The present invention relates to a method and apparatus for concentrating a fluid with improved energy efficiency. The method comprises the steps of: providing a membrane distillation unit having an evaporation side in fluid communication with a first reservoir for containing the fluid, and a condensation side being in fluid communication with a second reservoir for containing a coolant; evaporating at least a portion of the fluid and condensing the fluid in the second reservoir. The method further comprises the steps of controllably transferring heat from the coolant to the fluid such that the temperature of the fluid is maintained at a predetermined temperature.

### FIELD OF THE INVENTION

The present invention relates to a method and apparatus for concentrating fluids, and will be described hereinafter with reference to this application. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Many commercially important products in a variety of industries are produced at low solids content. For example, in the pharmaceutical industry certain biomolecules, such as proteins, are produced at concentrations of around 1 to 10%. Other examples in the food industry are fruit juices, which are also produced at low concentrations when freshly squeezed. The concentration of such products is clearly an important unit operation since, for example, concentration of fruit juices to reduce the total amount of water reduces packaging, storage and transport costs, and the final concentrate may actually have improved stability. Furthermore, not only is the concentration of such products important, but the method in which they are concentrated, since many of these products have properties which are thermally sensitive, and hence not all concentration unit operations may be appropriate.

According to a World Bank report in 2005, international production of fruit in 2003 reached 1,274 million tons, and 29.6% of this fruit was further processed into fruit juice. It has been estimated by some that the yield of juice extraction is approximately 40% with about half of those juices being subject to concentration. Accordingly, the weight of fruit juice subject to concentration internationally is estimated at 75 million tons per annum. Such a vast quantity of product highlights the need for efficient, cost effective concentration processes for application in such industries.

Concentration of fruit juices is usually performed by conventional vacuum evaporation, which typically results in product deterioration (e.g. loss of aroma, flavour, nutrients and colour) leading to a lower quality final product having poor consumer acceptance. Alternate processes, including freeze concentration, have limitations with regards to maximum concentration achievable (typically only up to 40 to 45° B). Since both processes involve a change of phase, energy consumption in each technique is relatively high.

Osmotic distillation (OD) and direct contact membrane distillation (DCMD) have relatively recently emerged as alternatives to other concentration techniques when high final concentration and quality of product are required. The schematic principle of the two processes is shown in FIG. 1. In these processes, water molecules at the feed-membrane interface vaporise, then diffuse through the membrane, condense at the membrane-stripping solution interface, and are eventually swept away by the “stripping” solution. However, these two processes differ in the manner whereby the water vapour pressure difference is created across the membrane surface. While OD uses hygroscopic brine as a stripping solution, DCMD relies on the temperature difference across the membrane to create the process driving force. However, industry has tended to move away from OD concentration processes since brine is corrosive to equipment, it must be re-concentrated once used, and poor consumers' perception that a “chemical” has been used to concentrate the foodstuff.

As an alternative concentration technique, DCMD replaces a chemical solution with cold water, thereby avoiding the need for a concentrated brine stripping solution. DCMD refers to a thermally driven transport of volatile species within the feed, typically water, through microporous hydrophobic membranes. To explain, the membrane is maintained between a hot solution (i.e., feed side) and suitable liquid such as cold pure water (i.e., permeate side). Due to the hydrophobic nature of the membrane, the aqueous phases cannot penetrate inside the dry membrane pores unless a trans-membrane hydrostatic pressure exceeding the liquid entry pressure of water (LEPw), which is characteristic of each membrane, is applied. In this manner the trans-membrane vapour pressure, which is the driving force in MD, is created by maintaining a temperature difference between both liquids. Under these conditions, evaporation takes place at the hot feed interface and, after water vapour is transported through the membrane pores, condensation takes place at the cold permeate interface inside the membrane module.

DCMD systems provide many advantages over other separation operations. These advantages include the almost complete rejection of non-volatile species present within the feed such as ions, colloids, macromolecules as they are unable to evaporate and diffuse across the membrane, lower operating pressures than pressure-driven membrane processes and a reduced vapour space when compared to conventional distillation processes. However, DCMD is also not without its limitations, suffering from problems associated with membrane wetting, temperature polarization and relatively low flux. Also, DCMD has relatively low energy efficiency in comparison to other processes.

DCMD systems are known in the art which create a temperature differential between a feed fluid and a cooling fluid for effecting distillation for obtaining pure water from crude or contaminated feed fluid. However, these prior art systems are designed and optimized for efficient production of pure water. For example, significant research has been conducted into optimizing the membrane, the feed fluid and a cooling fluid temperature differentials, and relative flow rates, etc. However, generally speaking for a given flow rate and membrane, maximizing the temperature differential between the feed fluid stream and the cooling fluid stream (whilst keeping the permeate stream above 0° C.) and/or operating at relatively high temperatures will maximize the distillation process and thereby maximize the production of pure water. Whilst such systems are designed to maximize the output of pure water they tend to be energy inefficient, since maximizing the temperature differential between the feed and permeate is energy intensive. Furthermore, such systems are inadequate for concentrating fluids having thermo-sensitive properties, such as fruit juices.

It is an object of the present invention to overcome or ameliorate at least one of the disadvantages of the prior art, or to provide a useful alternative.

### SUMMARY OF THE INVENTION

According to a first aspect, the present invention provides apparatus for concentrating a fluid, said apparatus comprising:
a distillation unit having an evaporation side being in fluid communication with a first reservoir for containing said fluid, and a condensation side being in fluid communication with a second reservoir for containing a coolant, wherein said fluid is evaporable from said evaporation side and condensable in said condensation side thereby concentrating said fluid; and
a heat pump being adapted to transfer heat from said coolant to said fluid such that the temperature of said fluid is maintainable at a predetermined temperature.

According to a second aspect, the present invention provides a method for concentrating a fluid, said method comprising the steps of:
providing a distillation unit having a temperature differential between an evaporation side and a condensation side, said evaporation side being in fluid communication with a first reservoir for containing said fluid, and said condensation side being in fluid communication with a second reservoir for containing a coolant;
evaporating said fluid from said first reservoir and condensing said evaporated fluid in said second reservoir; and
transferring heat from said coolant to said fluid such that the temperature of said fluid is maintainable at a predetermined temperature.

Preferably heat is controllably transferred from the coolant to the fluid such that the temperature of the fluid is maintainable at, or controllable to, a predetermined temperature. Preferably the membrane distillation unit is adapted for distillation of at least a portion of the fluid.

Preferably the distillation unit is a membrane distillation unit. Preferably a hydrophobic porous membrane is provided and interposed between the evaporation side and the condensation side.

Preferably the fluid is distilled or evaporated at atmospheric pressure, however, alternatively distillation could be effected at higher or lower pressures as required and depending on the fluid being distilled.

In one embodiment the first and second reservoirs are stirred tanks. However in alternative embodiments the first and second reservoirs are fluid circuits adapted to circulate said fluid and said coolant respectively. Preferably the first fluid circuit is provided for circulating a feed fluid which is to be distilled and the second fluid circuit is provided for circulating a coolant and for receiving a distillate or condensate produced by distillation of said feed. Preferably the fluid from the first fluid circuit is distilled through a membrane distillation unit by evaporating at least a portion of the fluid to form steam and condensing the steam in the second fluid circuit.

Preferably the evaporation side of said distillation unit is provided in the first fluid circuit and the condensation side is provided in the second fluid circuit.

According to third aspect, the present invention provides use of a heat pump in a distillation process comprising a distillation unit having an evaporation side being in fluid communication with a first reservoir for containing a fluid, and a condensation side being in fluid communication with a second reservoir for containing a coolant, wherein said heat pump is adapted to transfer heat from said coolant to said fluid such that the temperature of said fluid is maintainable at a predetermined temperature. Preferably the distillation process is a membrane distillation process.

According to fourth aspect, the present invention provides a method for controlling a membrane distillation process comprising a distillation unit, the method comprising the steps of:
providing a fluid on one side of said distillation unit;
providing a coolant on the other side of said distillation unit; and
transferring heat from said coolant to said fluid such that the temperature of said fluid is maintainable at a predetermined temperature.

Preferably a temperature differential is established between the coolant and fluid thereby effecting distillation of said fluid.

According to one embodiment, the present invention provides a method for concentrating a fluid, said method comprising the steps of:
circulating said fluid on one side of a hydrophobic porous barrier;
simultaneously circulating a coolant of a relatively lower temperature on the opposite side of said porous barrier, said coolant being cooled with a cooling unit having a heat radiating side, wherein solvent from said fluid is transferred across said porous barrier in the vapour state substantially solely under the influence of a temperature gradient to said coolant resulting in concentration of said fluid; and
transferring heat from said heat radiating side of said cooling unit to said fluid such that the temperature of said fluid is controllable to a predetermined temperature.

In a related embodiment the present invention provides a method for concentrating a fluid, said method comprising the steps of:
providing a distillation unit having a temperature differential between an evaporation side and a condensation side, said evaporation side being in fluid communication with a first reservoir for containing said fluid, and said condensation side being in fluid communication with a second reservoir for containing a coolant;
providing a cooling unit adapted to maintain said coolant at a predetermined temperature, said cooling unit having a heat radiating side; and
evaporating at least a portion of said fluid and condensing said evaporated fluid in said second reservoir,
whereby heat is controllably transferred from said heat radiating side of said cooling unit to said fluid such that the temperature of said fluid is maintained at a predetermined temperature.

In a further related embodiment, the present invention provides a distillation apparatus for concentrating a fluid, said apparatus comprising:
a distillation unit having an evaporation side being in fluid communication with a first reservoir for containing said fluid, and a condensation side being in fluid communication with a second reservoir for containing a coolant;
a cooling unit adapted to maintain said coolant at a predetermined temperature, said cooling unit having a heat radiating side; and
a controller for transferring heat from said heat radiating side of said cooling unit to said fluid such that the temperature of said fluid is maintained at a predetermined temperature.

In one embodiment a cooling unit is provided which is in heat transfer communication with the second reservoir and the coolant fluid contained therein. The distillate is cooled with the cooling unit which has a heat radiating side. Preferably heat is transferred from the heat radiating side of the cooling unit to the fluid such that the temperature of the fluid is maintainable or controllable to a predetermined temperature.

Preferably the heat generated from the heat radiating side of the cooling unit is controllably transferred to the fluid to be concentrated such that the temperature of the fluid is maintained at a predetermined temperature. Preferably a controller is utilised for controlling the transfer of heat from the heat radiating side of the cooling unit to the fluid. The controller can be a PID-type controller or an on-off type controller. It will be appreciated that the heat may be transferred to the fluid by any means, for example a heat exchanger. In another example a counter-current flow heat exchanger could also be used to transfer the waste heat from the permeate to the feed fluid.

Preferably sufficient heat is transferred to the fluid being concentrated to maintain the predetermined temperature and the residual or balance of the heat is diverted or lost to atmosphere.

Preferably a heat pump is provided which is adapted to transfer heat from the coolant to the feed such that the temperature of the fluid is maintainable at a predetermined temperature. As the skilled person will appreciate, the feed temperature is limited (e.g. to 45° C.) and the permeate temperature limited (e.g. to above 5° C.), and therefore the flux through the membrane is somewhat limited. Since the permeate outlet temperature is preferably lower than the feed outlet temperature, heat exchangers have no effectiveness to recover the waste heat. Therefore, the present inventors have found that a heat pump can be used to simultaneously cool the coolant and controllably heat the feed fluid.

The present invention relates to the concentration of fluids, and in particular, the concentration of dilute fluids. The “feed” fluid admitted to the evaporation side of the membrane distillation unit is the fluid to be concentrated, which is typically dilute, and the fluid exiting the membrane distillation unit on the evaporation side is a concentrate of the feed fluid. A cooling fluid, which is typically water, is admitted to the condensation side of the membrane distillation unit and receives the distilled water (or permeate) from the distillation process. Accordingly, the membrane distillation unit is adapted for distillation of at least a portion of the feed fluid, thereby concentrating the feed fluid. However, whilst the present invention is directed towards the concentration of a “valuable” feed fluid it may also be used to obtain “valuable” purified water from a less valuable feed fluid, such as brackish water or sewage.

The role of the membrane in DCMD is both to act as a physical barrier for the liquid streams while also allowing the transport of vapour from the evaporation side to the coolant side. To achieve this, the hydrophobicity of the membrane plays an important role. As such, membranes suited to this application are typically prepared from hydrophobic polymers such as ethylene chlorotrifluoroethylene (Halar), polytetrafluoroethylene (PTFE), polypropylene (PP), polyethylene (PE), or poly(vinylidene fluoride) (PVDF).

In preferred embodiments, the present invention is particularly suited for the concentration of fluids having thermo-sensitive or labile properties. For example, fruit juices are thermo-sensitive in the respect that exposure of the juice to excessive temperatures may result in a loss of organoleptic properties, or nutritional content. Other examples in the pharmaceutical and bio-pharmaceutical industries are the concentration of proteinaceous suspensions, such as from fermentation processes, and the preparation of vaccines. The present invention is also particularly useful for concentrating thermo-sensitive fluids such as coffee, tea, wine, and milk. Other thermo-sensitive fluids will be well known to the skilled person, for example the present invention can be utilised for concentrating whey proteins, foodstuffs, pharmaceuticals, nutraceuticals, proteinaceous suspensions, biological extracts, plant or vegetable extracts such as vegetable juices, and phytochemicals, etc.

In particularly preferred embodiments, the present invention relates to a process for improving the energy efficiency of a membrane distillation (MD) process for concentrating thermo-sensitive fluids by utilization of “waste” heat from a cooling unit and its discharge/transference into the feed fluid. The waste heat from the cooling unit is transferred by way of a suitable heat pump, wherein the heat pump is adapted to selectively transfer only sufficient of the waste heat to the feed to effect distillation and yet not affect the thermo-sensitive properties of the thermo-sensitive fluid being concentrated.

When concentrating thermo-sensitive fluids, not only is close temperature control of the feed required, the temperature of the feed must remain at below the temperatures at which the feed fluid deteriorates in order to preserve the thermo-sensitive properties of the feed fluid. Accordingly, since the temperature differential between the feed fluid and coolant fluid is limited due to the feed fluid “ceiling” or deterioration temperature, for example anywhere from 15 to 45° C., the driving force for distillation is therefore relatively low thereby making the process relatively inefficient and reducing the viability of the process for concentrating such thermo-sensitive fluids. Since the process is inefficient in terms of its ability to concentrate a feed fluid having a ceiling temperature, it is also energy inefficient. This has been well documented, i.e. see Bui, V. A., Nguyen, M. H., and Muller, J. in “The energy challenge of direct contact membrane distillation in low temperature concentration”, Asia-Pacific J. of Chem. Eng., 2(5), 400-406 (2007).

As discussed above, it has been found that the waste heat from the cooling unit cooling the cooling fluid/permeate can be utilized to advantageously heat the feed fluid, thereby reducing the energy requirements of the system, and as a consequence improving the overall energy efficiency. A heat pump can be advantageously used to transfer heat to the feed. Furthermore, due to the nature of the heat balances of the process overheating of the feed fluid may occur if all the waste heat from the cooling unit is transferred to the feed. Therefore, the present inventors have ameliorated this issue by transferring the waste heat from the cooling unit to the feed to effect distillation and yet maintain the thermo-sensitive properties of the feed fluid. This is achieved by selectively transferring only sufficient heat to maintain a predetermined temperature of the feed, wherein the predetermined temperature is below that at which the thermo-sensitive properties deteriorate. The configuration taught herein provides an energy efficient system since waste heat is utilized, however, is also particular adapted for thermo-sensitive fluids.

In preferred embodiments the heat pump of the invention comprises a cooling unit which is in heat transfer communication with the second reservoir and the coolant fluid contained therein, wherein the cooling unit comprises a heat radiating side. The cooling unit also comprises a heat exchanger and a main condenser. Preferably the heat pump is a mechanical vapour-compression refrigeration pump. Preferably the heat pump further comprises a solenoid valve and an additional condenser for balancing the energy flows in the system.

The present invention surprisingly provides improved response time to temperature control compared to prior art devices. The present inventors have surprisingly found that an additional condenser attached in parallel to the main condenser, which was used to heat the feed fluid, enabled any residual or excess heat to be relatively quickly diverted away into the atmosphere, thereby improving the thermal response time. Furthermore, in prior art devices if an additional condenser is employed it is typically attached in series with the main condenser, and longer thermal response times result. By using an additional condenser in the heat pump system it has been found that sufficient heat can be transferred to the feed fluid to maintain a predetermined temperature which is below that at which the feed fluid deteriorates and with improved thermal response times. In contrast, prior art systems seek to transfer all the available heat to the feed fluid to maximize thermal efficiency, and accordingly teach away from the present invention. Such prior art systems are incapable of concentrating thermally sensitive fluids. The present invention enables the concentration of thermally sensitive fluids since only sufficient heat is transferred to effect distillation and yet the thermally sensitive properties of the feed fluid are not affected by maintaining the feed fluid temperature below that at which it deteriorates. Furthermore the present inventors have found that by arranging the additional condenser in parallel the feed can be heated using the first condenser while any excess heat can be discarded in the additional condenser. In this parallel system, the present inventors have found a significantly improved response time and thereby improved control over the concentration processes. In an alternative embodiment the heat pump may comprise a combustion engine instead an electrical motor for the compressor.

In some embodiments, the present invention may eliminate the need for a separate heater for the feed fluid, since the waste heat which is utilized may be sufficient to heat the feed fluid to effect distillation, thereby reducing the energy requirements of the system. Other advantages of the present invention will be readily apparent to the skilled person.

As discussed previously, a temperature differential between the feed fluid and coolant is required to effect distillation. The temperature of the coolant should be below that of the feed fluid and is around 5 to 15° C., however is preferably 10° C. The skilled person will appreciate that lowering the coolant temperature below that of about 5° C. will actually reduce the energy efficiency of distillation, which is thought to be due to an increase in heat transfer and boundary layer effects. Without wishing to be bound by theory, it is thought that the mass flux is dependent upon the water vapour pressure. Preferably the coolant temperature is controlled or maintained to about 10° C., however, the coolant temperature may be controlled or maintained to 2, 3, 4, 5, 6, 7, 8, 9, 10, 11, 12, 13, 14, 15, 16, 17, 18, 19, 20, 21, 22, 23, 24, 25, 26, 27, 28 or 29° C.

The feed fluid temperature can be any temperature, however, when concentrating fluids having thermo-sensitive properties the temperature should be below that at which the thermo-sensitive properties deteriorate or are substantially affected. It will be appreciated that some thermo-sensitive properties may also be time-dependant, meaning that the fluid can be exposed for brief periods of time to temperatures in excess of the temperature at which the thermo-sensitive properties deteriorate, with little effect. However, relatively longer exposure will result in a marked decrease in those properties. In one embodiment, when concentrating orange juice, preferably the feed fluid temperature is maintained at about 45° C. during concentration. However, the feed fluid temperature may be 25, 26, 27, 28, 29, 30, 31, 32, 33, 34, 35, 36, 37, 38, 39, 40, 41, 42, 43, 44, 45, 46, 47, 48, 49, or 50° C. Generally speaking, the concentration efficiency of the feed will be maximized when the temperature differential of the feed and coolant is maximized, noting that the above-mentioned constrains on coolant temperature.

Preferably the transmembrane vapour pressure differential is maximised in order to maximise the flux through the membrane. In a high feed temperature distillation of say 90° C. a temperature difference of about 6° C. can generate a roughly 15 kPa vapour pressure differential across the membrane. However, a 6° C. temperature differential in a low feed temperature distillation of say 45° C. creates less than 1 kPa vapour pressure differential. Therefore, it is preferable to maintain a large ΔT to maximise flux with the constraints on the temperature of the feed being below that at which it deteriorates.

In one example the present invention is capable of concentrating orange juice from 12° Brix to anywhere from 43 to 75° Brix without substantially affecting the properties of the juice. However, it will be appreciated that other juices can be concentrated to different ° Brix depending on their properties, such as the amount of pulp, acid content and flavour compounds, etc.

In another example, the apparatus and method of the invention may concentrate a glucose solution up to 60% w/w at feed temperature just up to 40° C. However, it will be appreciated that a glucose solution could be concentrated to a greater or lower extent depending on the requirements. Generally speaking, higher concentrations can be achieved with longer processing times or larger membrane areas.

The person skilled in the art to which this present invention pertains will be familiar with the thermo-sensitive properties of particular fluids. As discussed already, one example is fruit juices, which tolerate temperatures of about 45° C. before deteriorating. The properties which may deteriorate are typically: colour, taste, aroma, flavour, nutrients, etc. Other examples are the concentration of gelatin and various enzymes, which may be decomposed by exposure to temperatures above 30° C. for long periods.

The present invention enables the concentration of a fluid at surprisingly high energy efficiencies. To explain, when the feed fluid is at very high temperatures, say 80 to 90° C., only a small temperature difference between the feed fluid and coolant is required to create a large transmembrane water vapour pressure which will provide an adequate mass flux. However, when the temperature that the feed fluid can be raised to is relatively low, say 40° C., the transmembrane water vapour pressure is low and the resulting mass flux is low, making the process relatively energy inefficient. However, recovery of a portion of the waste heat from the cooling unit to heat the feed fluid to a predetermined temperature below the deterioration temperature significantly improves the energy efficiency. Operating a membrane distillation process without the present invention at low temperatures results in low energy efficiencies, making the process unaffordable and therefore unattractive compared to other concentration processes which can concentrate a fluid at low temperatures. However, the present invention makes the membrane distillation process viable compared to these other processes since the energy efficiency is now comparable to or better than other methods of concentrating thermally sensitive fluids.

In preferred embodiments the apparatus of the invention is configured for counter current flow in the first and second fluid circuits. However, it will be appreciated that the fluid in the fluid circuits could be configured for unidirectional circulation. In other embodiments, the present Applicant contemplates that the first and second fluid circuits could be configured as stirred tanks, which are interconnected by a membrane from a membrane distillation unit. However, the skilled person will appreciate that other configurations would fall within the purview of the present invention.

The present invention may also be coupled with other concentration processes. For example Reverse Osmosis can be used to conduct an “initial” concentration step to achieve a concentration of say 35%, and then the present invention can be used to further concentrate the solution from 35% up to 65%.

In an alternative example, a initial freeze concentration process can be utilised to perform to achieve an initial concentration of say 35%, and the present invention can be used to further concentrate the solution up to 65% or higher. In this example the refrigeration unit in freeze concentration process can be used for the heat pump of the membrane distillation; while the cold water removed from the freeze concentration process can be readily used as the coolant for the membrane distillation.

The coolant could be cooled at any point in the circuit provided that the temperature of the coolant flowing through the condensation side of the membrane distillation unit is maintained at a predetermined temperature, which is preferably about 10° C. as discussed above. However, in order to improve overall energy efficiency preferably the cooling unit cools the coolant prior to the coolant entering the membrane distillation unit, i.e. upstream of the membrane distillation unit. Similarly, the feed fluid could be heated at any point in the circuit provided that the temperature of the feed fluid flowing through the evaporation side of the membrane distillation unit is maintained at a predetermined temperature, which is about 45° C. as discussed above. However, in order to improve overall energy efficiency, and in order to minimize overheating, preferably a heat pump transfers heat to the feed fluid prior to the feed fluid entering the membrane distillation unit, i.e. upstream of the membrane distillation unit.

As discussed in the foregoing, the “waste” heat from the cooling unit is transferred/redirected to the feed fluid to maintain a predetermined temperature. In some embodiments the entire waste heat is redirected to the feed fluid circuit to raise the feed fluid to the predetermined temperature. However, in other embodiments only a portion of the waste heat may be required to raise the feed fluid temperature to the predetermined temperature. In these embodiments the excess waste heat is simply lost to atmosphere, or may even be utilized for other purposes, for example for apparatus of the invention configured in parallel/series. It will also be appreciated that the amount of waste heat produced by the cooling unit is dependent upon the amount of work that the cooling unit is required to perform in order to maintain the coolant at a desired temperature, which is dependent upon the relative size of the cooling unit and the flow rate of coolant. It will also be appreciated that the apparatus of the invention could be configured such that the flow rates of coolant and feed fluid are such that the waste heat produced by the cooling unit is substantially consumed by the feed fluid, thereby improving the overall energy efficiency of the process. It will be appreciated that the flow rates of the feed fluid and coolant may be the same or different.

The present invention is adapted to concentrate thermally sensitive fluids by a membrane distillation process in an energy efficient manner and at a relatively low capital and operating cost. It will be appreciated that the temperature differential is sufficiently high to obtain distillation and yet the feed fluid is not overheated so as to deteriorate or spoil the feed fluid being concentrated/distilled.

It will be appreciated that a temperature sensor may be required to monitor the temperature of the feed fluid entering the membrane distillation unit, and for providing feedback control to the heat pump for selectively adjustably admitting sufficient heat to maintain the feed fluid temperature at substantially the predetermined temperature. Such feedback control would be well known to the skilled person, e.g. on-off and PID control. Preferably the temperature sensor is positioned upstream of the membrane distillation unit, however could also be positioned within or even post- the membrane distillation unit. Preferably the heat pump is responsive to the temperature sensor to transfer heat to the feed fluid to control the temperature of the feed fluid to a predetermined temperature.

The skilled person will appreciate that a heat exchanger may be used to recover heat from the cooling unit and redirect it to the feed fluid circuit. However, since the temperature difference between the feed fluid and the cooling fluid is required to be relatively high preferably a heat pump is used. Preferably the vapour-compression refrigeration technique is used, in which heat is transferred from a lower temperature source (the cooling fluid) to a higher temperature heat sink (the feed fluid).

The level of energy recovery, or energy efficiency, of a refrigeration system is usually referred to as the coefficient of performance (COP), and is usually expressed as the ratio of useful heat output to the amount of energy used to drive the compressor (or supplied work). The higher the COP, the more efficient the heat pump. At favourable operating conditions, such as those for air conditioning applications, the COP of a single stage refrigerator usually ranges from 4 to 5 when used for cooling, and 5 to 6 when used for heating. For example, if the COP of a heat pump is 4, it removes 4 units of heat for every unit of energy consumed. Mechanical vapour-compression refrigeration offers a great potential to substantially reduce the amount of energy used in a MD system that operates at low feed temperatures. For example, if an MD process such as the process described herein requires a total of 5 kW, and the heat pump can deliver a COP=5, then only an input of 1 kW of electrical energy is required to operate the system. Or in other words, 80% of the energy is “recovered” for use in the feed stream.

Whilst the present invention has been discussed in the foregoing with reference to the concentration of fruit juices, it will be appreciated that the apparatus and method of the invention is also applicable for the removal of water from a liquid such as seawater, brackish water or liquid effluent. This is particularly important when overall energy consumption is an issue.

In a further embodiment, the present invention can also be used to produce and to recover at least part of the energy potential which exists between the two fluids, one of low temperature, i.e. the permeate, and one of relatively higher temperature, i.e. the feed.

According to a further aspect the present invention provides a membrane distillation process adapted for concentrating a thermally sensitive fluid, wherein during distillation the temperature of said fluid is kept under its deterioration temperature and wherein the energy efficiency of the distillation process is greater than 60%. The deterioration temperature may be 25, 26, 27, 28, 29, 30, 31, 32, 33, 34, 35, 36, 37, 38, 39, 40, 41, 42, 43, 44, 45, 46, 47, 48, 49, or 50° C. The energy efficiency of the process as defined herein may be greater than 60%, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, or 250%.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

To provide a more concise description, some of the quantitative expressions given herein are not qualified with the term “about”. It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value. The examples are not intended to limit the scope of the invention. In what follows, or where otherwise indicated, “%” will mean “weight %”, “ratio” will mean “weight ratio” and “parts” will mean “weight parts”.

### BRIEF DESCRIPTION OF THE DRAWINGS

A preferred embodiment of the invention will now be described, by way of example only, with reference to the accompanying drawings in which:

FIG. 1 is a schematic of the principles underlying the processes of osmotic and membrane distillation, wherein water vapour transfers through the hydrophobic membrane from the feed solution having a high water vapour pressure to the stripping solution side with a low water vapour pressure;

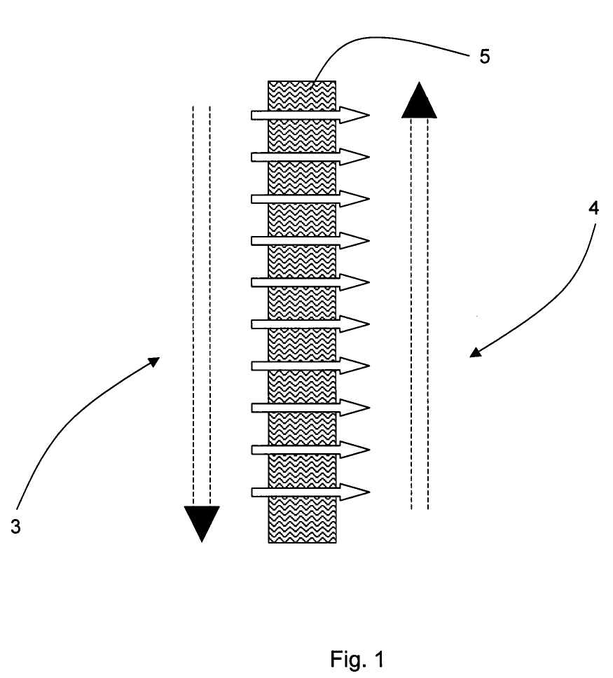

FIG. 2 is a diagram of the novel process of the present invention;

FIG. 3 is a schematic of a MD process according to the invention;

FIG. 4 is a temperature vs time graph recording the temperatures of the feed fluid and permeate during a concentration process; and

FIG. 5 is a concentration and mass flux graph vs time of the concentration process shown in FIG. 4.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The recitation of a numerical range using endpoints includes all numbers subsumed within that range (e.g., 1 to 5 includes 1, 1.5, 2, 2.75, 3, 3.80, 4, 5, etc.).

The term “Brix” is a measure of sugar content, and a Brix unit (° B) is defined as the percentage of sugar (sucrose) by weight (grams per 100 milliliter of water) in a solution and is usually used to indicate the amount of solubles in a solution.

The terms MD (membrane distillation) and DCMD (direct contact membrane distillation) are used interchangeably herein.

### PREFERRED EMBODIMENT OF THE INVENTION

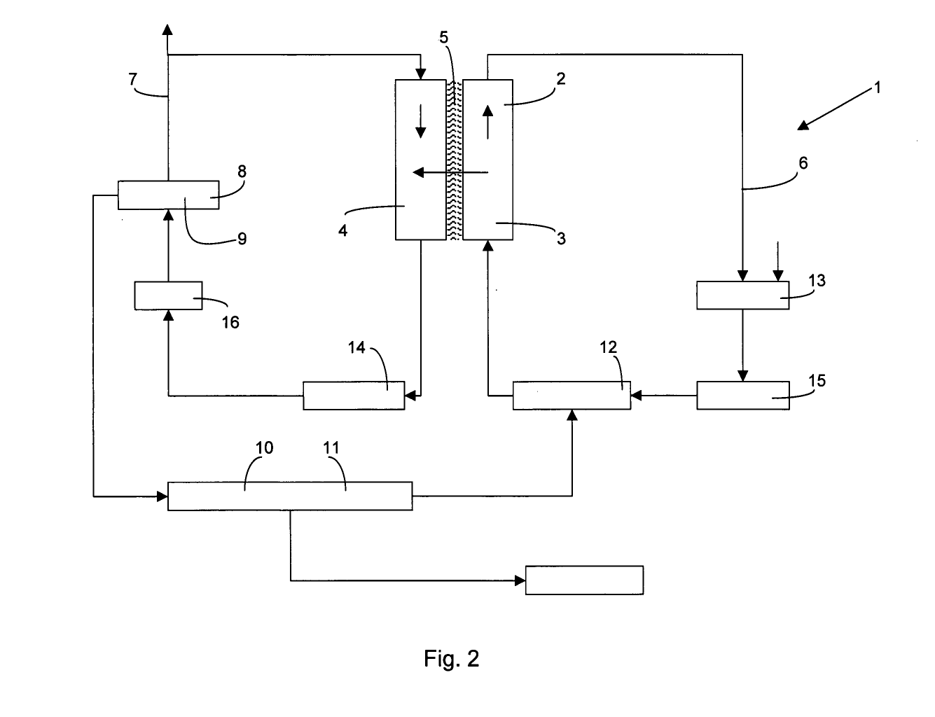

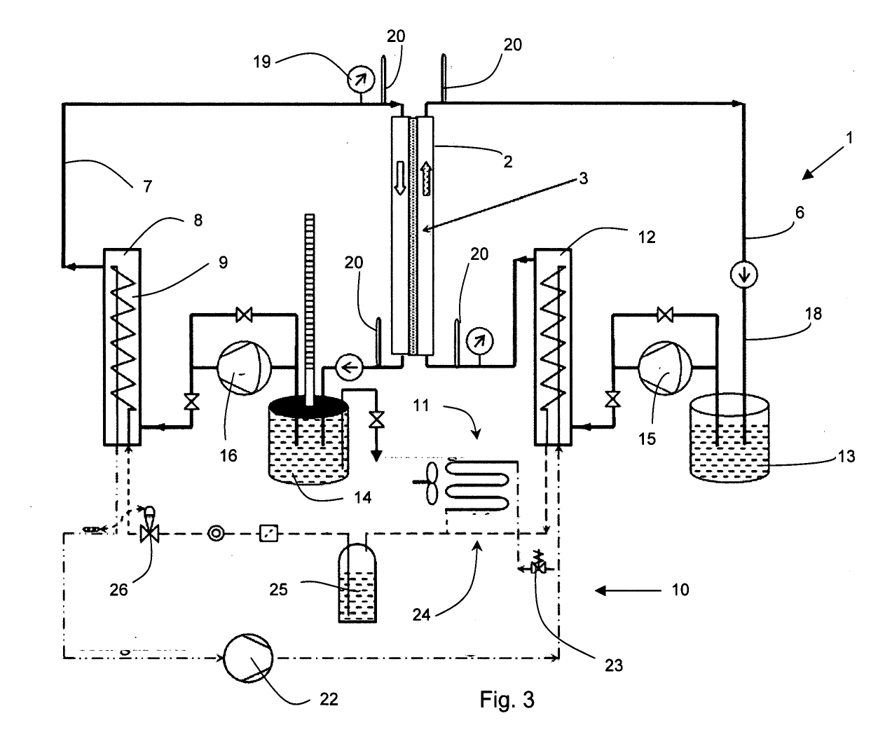

Throughout the figures presented herein like features have been given like reference numerals. By way of disclosing a preferred embodiment, and not by way of limitation, there is shown in FIGS. 2 and 3 an energy efficient MD apparatus 1 for concentrating a dilute thermo-sensitive fluid, such as a fruit juice. The apparatus comprises a membrane distillation unit 2 having an evaporation side 3 and a condensation side 4 and a hydrophobic porous membrane 5 interposed between the evaporation side 3 and the condensation side 4. The evaporation side 3 is in fluid communication with a first fluid circuit 6 adapted to circulate the feed fluid (e.g. orange juice), and the condensation side 4 in fluid communication with a second fluid circuit 7 adapted to circulate a coolant, which is typically water. The feed fluid is admitted to the evaporation side 3 of the membrane distillation unit 2 and the fluid exiting the membrane distillation unit 2 on the evaporation side 3 is a concentrate of the feed fluid. Cooling water is admitted to the condensation side 4 of the membrane distillation unit 2 and receives the distilled water (or permeate) from the distillation process. Accordingly, the membrane distillation unit 2 is adapted for distillation of at least a portion of the feed fluid, thereby concentrating the feed fluid.

A cooling unit 8 in the form of a heat exchanger 9 is provided in the second fluid circuit 7, and has a heat radiating side (not shown). Further, a heat pump 10 is provided in heat transfer communication with the heat radiating side of the cooling unit 8 and the first fluid circuit 6. The heat pump 10 in the form of a condenser 12 is adapted to control the temperature of the feed fluid to a predetermined temperature by selectively controlling the amount of heat transferred to the feed fluid. The heat pump 10 is adapted to selectively transfer only sufficient of the “waste” heat from the cooling unit 8 to the feed fluid to effect distillation and yet not affect the thermo-sensitive properties of the thermo-sensitive fluid being concentrated. Preferably the vapour-compression refrigeration technique is used, in which heat is transferred from the lower temperature source (the cooling fluid) to a higher temperature heat sink (the feed fluid).

It has been discovered that waste heat from the cooling unit 8 can be utilized to advantageously heat the feed fluid, thereby reducing the energy requirements of the system (or conversely improve the energy efficiency). However, due to the nature of the heat balances of the process, overheating of the feed fluid may occur if all the waste heat from the cooling unit 8 is transferred to the feed fluid. Therefore, the present Applicant has adapted prior art MD processes for use with thermo-sensitive fluids by utilizing a heat pump 10 for transferring the waste heat from the cooling unit 8 to the feed wherein the heat pump 10 transfers only sufficient heat to the feed to effect distillation and yet maintain the thermo-sensitive properties of the feed fluid. The configuration taught herein provides an energy efficient system since waste heat is utilized, however, is also particular adapted for thermo-sensitive fluids.

The temperature of the water coolant is preferably about 10 to 25° C., and the temperature of the feed fluid is dependent upon the particular feed fluid being concentrated, however, is typically about 45° C. when concentrating, say, orange juice. It will be appreciated that the temperature of the feed fluid should be maintained below that at which the thermo-sensitive properties of feed fluid deteriorate. In the case of fruit juices, the properties that may deteriorate are: colour, taste, aroma, flavour, nutrients, etc. Preferably the orange juice is concentrated from 12° B to 65° B by the novel apparatus and method of the present invention.

In one example, a novel method of the present invention comprises the steps of: circulating a feed fluid in the first fluid circuit 6, circulating a water coolant in a second fluid circuit 7, and distilling the feed fluid from the first fluid circuit 6 through a membrane distillation unit 2 by evaporating at least a portion of the feed fluid to form steam and condensing the steam in the second fluid circuit 7. The method also comprises the steps of: cooling the distillate with a cooling unit 8 having a heat radiating side, and selectively transferring heat from the heat radiating side of the cooling unit 8 to the feed fluid such that the temperature of the fluid is controllable to a predetermined temperature.

As already discussed, the waste heat from the cooling unit 8 is selectively transferred to the feed fluid to maintain a predetermined temperature. In some embodiments the entire waste heat is redirected to the feed fluid, however, in other embodiments only a portion of the waste heat may is required to raise the feed fluid temperature to the predetermined temperature. In these embodiments the excess waste heat is simply lost to atmosphere.

The coolant is preferably cooled prior to the coolant entering the membrane distillation unit 2, and the heat pump 10 transfers heat to the feed fluid prior to the feed fluid entering the membrane distillation unit 2. Reservoirs 13 and 14 are also provided for the feed and permeate respectively. Also, suitable pumps 15 and 16 are provided for pumping the feed and permeate through the first fluid circuit 6 and second fluid circuit 7 respectively. Means for measuring the flux is also provided, which may take the form of a pipette (not shown) or similar device, however this is optional.

Referring in particular to FIG. 3, it can be seen that preferably a number of flow meters 18, pressure gauges 19, and thermometers 20 are provided to monitor and control the apparatus of the invention. The preferred heat pump 10 is in the form of a mechanical vapour-compression refrigeration pump, which comprises an evaporator 8, a condenser 12, a compressor 22, a solenoid valve 23, an additional condenser 24, a receiver 25, and a thermo-expansion valve 26. The additional condenser 24 and the solenoid valve 23 were installed for balancing the energy flows in the system and the additional condenser 24 is installed in parallel with the main condenser 12 to accurately control the temperature of the feed within a relatively short response time.

Comparison of energy efficiency, cost and product quality of concentration techniques is listed in Table 1. It can be seen from the inspection of the data provided in Table 1 that the energy cost for MD in the fruit juice industry is reduced to the level comparable to one-stage EC and OD processes. However, it should be noted that the present invention is compact, flexible and mobile, and requires significantly lower investment than EC and OD processes.

TABLE 1
Energy consumption of various concentration techniques

| | Energy consumption | | AU$/metric | |
|---|---|---|---|---|
| | Steam equivalent | Mode of | ton water | Product |
| Process | (metric ton) | energy | removed | quality |
| EC one stage | 1.25-1.32* | Thermal | 14.7-15.6 | Low |
| EC four | 0.45* | Thermal | 5.3 | Low- |
| stages | | | | medium |
| FC | 0.25-0.50* | Electrical | 12.5-25 | High |
| RO | 0.48* | Electrical | 24 | High |
| OD | 1.32 | Thermal | 15.6 | High |
| MD | 1.67-3.33 | Thermal | 19.7-39.3 | High |
| conventional | (equivalent to | Electrical | 57.9-115.6 | |
| | efficiency of 30-60%) | | | |
| MD adapted | 0.42-0.83 | Electrical | 11.5-28.8 | High |
| according to | (e.g. COP = 4) | | | |
| the present | | | | |
| invention | | | | |

NOTES:
1.)* adopted from Ramteke, Singh et al. 1993;
2.) Prices are calculated as 1.7 cents/thermal kWh; and 5 cents/electrical kWh, 1 metric ton steam = 2,500 MJ.

The present invention is adapted to concentrate thermally sensitive fluids by a membrane distillation process in an energy efficient manner and at a relatively low capital and operating cost. It will be appreciated that the temperature differential is sufficiently high to obtain distillation and yet the feed fluid is not overheated so as to deteriorate or spoil the feed fluid being concentrated/distilled.

### EXAMPLES

The present invention will now be described with reference to the following example, which should be considered in all respects as illustrative and non-restrictive.

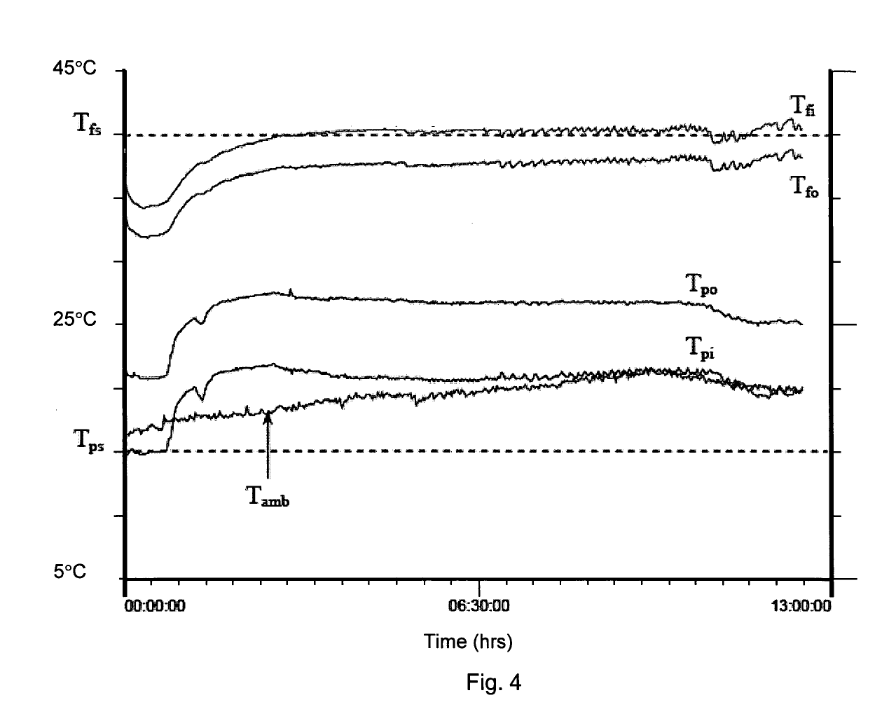

A bench-scale MD process was adapted according to the present invention for concentrating glucose (shown schematically in FIGS. 2 and 3), and was operated at the following conditions:
Feed fluid inlet temperature −T_{fi}=40° C.
Permeate inlet temperature −Tₚᵢ=20° C.
Velocities of the feed fluid ω_{f}=0.6 m·s⁻¹
Velocities of the permeate fluid ω_{f}=0.5 m·s⁻¹
Feed fluid was a glucose solution at 30% (w/w)
Membrane module HL50 (Siemens Water Technologies, Australia)
(FIG. 4 note: T_{fo}=temperature of the feed outlet, and Tₚₒ, is the temperature of the permeate outlet)

A glucose solution was concentrated from 30 to 60% (w/w) (4.2 kg of glucose) over approximately 13 hours (this time would be shorter if a module with larger membrane area was available). The temperature change of the two streams is shown in FIG. 4. It can be seen that, initially, the feed temperature dropped which can be attributed to the heat lost for heating up all the pipelines of the system. It then took about 2.5 hours for the feed inlet temperature to reach to its set point of 40° C.

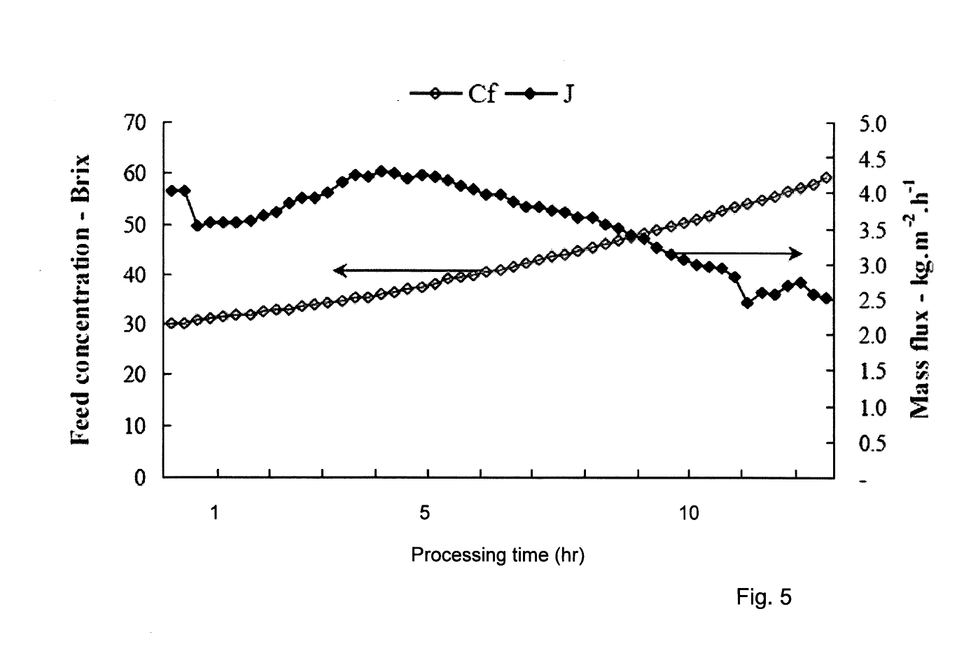

During the concentration operation, the amount of water removed from the feed was recorded by pipette while feed concentration was measured by a refractometer. Measurements were made over every 15 minutes. The feed concentration reached desired 60% (w/w) after 750 minutes and the concentrate exhibited no appreciable deterioration. The measured mass flux and feed concentration (converted to percentage of total solid on weight to weight basis) were calculated and the results are shown in FIG. 5.

The flux initially increased due to increased transmembrane temperature difference, then gradually decreased due to the effect of increased feed concentration. The average mass flux over the entire concentration process was about 3.6 kg·m⁻²·h⁻¹.

Overall assessment of energy efficiency of the MD system adapted according to the present invention was based on the total amount of water removed from the feed and the total amount of electricity consumed by the motor driving the compressor.
Total amount of water removed:
ΔM=2090.2 g, or equivalent to an usable latent heat of E_{diff}=5,037 kJ
Total electricity consumed by the compressor's motor:

E_{comp}=Qₘₒₜₒᵣ×time×Rₜᵢₘₑ=105×(750×60)×1.0=4,725 kJ
Total electricity consumed by the pumps:

$$\begin{matrix}{E}_{pump} = {\int }_{0}^{t} {\sum }_{j} {Q}_{pump}^{j} d t \\ = {\int }_{0}^{t} {\sum }_{j} {\dot{m}}_{j} ( 1 + 0.15 ) Δ {p}_{j} d t \\ \approx 148 kJ\end{matrix}$$

Total energy consumed by a MD process without an additional heat pump as per the instant invention:

$$\begin{matrix}{E}_{DCMD} = {\int }_{0}^{t} ( {Q}^{F} + {Q}_{pump} ) d t \\ = 11 , 670 kJ\end{matrix}$$

Thus, the total energy efficiency of the MD process without an additional heat pump as per the instant invention, and by the novel MD system as per the present invention in the batch concentration operation were estimated as:
Total energy efficiency of the MD process without an additional heat pump as per the instant invention:

$$\begin{matrix}{EE}_{DCMD} = \frac{{E}_{diff}}{{E}_{DCMD}} \\ = \frac{5037}{11670} \\ \approx 0.431\end{matrix}$$

$$or {EE}_{DCMD} \approx 43.1 \%$$

Total energy efficiency by the novel MD system of the present invention:

$$\begin{matrix}{EE}_{DCMD - R} = \frac{{E}_{diff}}{{E}_{comp} + {E}_{pump}} \\ = \frac{5037}{4725 + 148} \\ \approx 1.03\end{matrix}$$

$$or {EE}_{DCMD - R} \approx 103 \%$$

The MD process adapted according to the present invention improves the total energy efficiency of the MD concentration process, increasing from 43.1% of the process (for a prior art system with no heat recovery) to 103%. However, the present Applicant contemplates that “apparent” energy efficiencies of over 200% are possible. The relatively high energy efficiencies obtainable with the preset invention are due to the presence of the heat pump with its high coefficient of performance. The present applicant contemplates that the cost of the installation of the additional refrigeration system (heat pump) is more than offset by the reduced cost of operating the system due to the improved overall energy efficiency.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An apparatus for concentrating a fluid, said apparatus comprising:
a distillation unit having an evaporation side being in fluid communication with a first reservoir for containing said fluid, and
a condensation side being in fluid communication with a second reservoir for containing a coolant, wherein said fluid is evaporable from said evaporation side and condensable in said condensation side thereby concentrating said fluid; and
a heat pump being adapted to transfer heat from said coolant to said fluid such that the temperature of said fluid is maintainable at a predetermined temperature.

2. The apparatus according to claim 1 wherein said distillation unit is a membrane distillation unit, wherein said membrane of said membrane distillation unit is interposed between said evaporation side and said condensation side.

3. The apparatus according to claim 2 wherein said membrane comprises a hydrophobic porous membrane selected from the group consisting of Halar, PTFE, PP, PE, PVDF and combinations thereof.

4. (canceled)

5. The apparatus according to claim 3 wherein said membrane comprises Halar fibres.

6. The apparatus according to claim 1 wherein said heat pump comprises a cooling unit which is in heat transfer communication with the second reservoir and the coolant contained therein, wherein said cooling unit comprises a heat radiating side.

7. The apparatus according to claim 6 wherein said cooling unit comprises a heat exchanger.

8. The apparatus according to claim 6 wherein said heat pump comprises a main condenser.

9. The apparatus according to claim 6 wherein said heat pump comprises a mechanical vapour-compression refrigeration pump.

10. The apparatus according to claim 9 wherein said heat pump further comprises a solenoid valve and an additional condenser for balancing the energy flows in the system.

11. The apparatus according to claim 10 wherein the additional condenser is installed in parallel with the main condenser.

12. The apparatus according to claim 6 wherein said heat pump comprises a combustion engine.

13. The apparatus according to claim 6 wherein said cooling unit cools said coolant to between about 3 to about 15° C.

14. The apparatus according to claim 1 wherein said heat pump transfers sufficient heat to said fluid to raise the temperature of said fluid to said predetermined temperature, and wherein said predetermined temperature is selected from a temperature between about 25 to about 45° C.

15. (canceled)

16. The apparatus according to claim 1 wherein the vapour pressure differential between said fluid and said coolant is maintained at less than about 10 kPa during distillation.

17. The apparatus according to claim 1 wherein said first and second reservoirs are fluid circuits adapted to circulate said fluid and said coolant respectively.

18. The apparatus according to claim 17 wherein said feed fluid and said coolant are circulated in their respective fluid circuits in a counter current flow.

19. The apparatus according to claim 1 wherein said fluid comprises thermosensitive materials.

20. The apparatus according to claim 19 wherein said fluid is selected from the group consisting of: foodstuffs, pharmaceuticals, nutraceuticals, proteinaceous suspensions, plant extracts, vegetable extracts, biological extracts and phytochemicals.

21. The apparatus according to claim 20 wherein said fluid is fruit juice or orange juice.

22. (canceled)

23. The apparatus according to claim 1 further comprising a control system for controlling heat transfer and maintaining said feed fluid and said coolant at predetermined temperatures.

24.-44. (canceled)
